(19) United States
(12) Patent Application Publication
(10) Pub. No.: US 2015/0355002 A1
(43) Pub. Date: Dec. 10, 2015

(54) CLAMP-ON ULTRASONIC FLOWMETER AND FLOW RATE MEASURING METHOD

(71) Applicant: Azbil Corporation, Tokyo (JP)

(72) Inventors: Hiroshi SASAKI, Tokyo (JP); Yasuaki HIROE, Tokyo (JP)

(73) Assignee: Azbil Corporation, Tokyo (JP)

(21) Appl. No.: 14/734,741

(22) Filed: Jun. 9, 2015

(30) Foreign Application Priority Data
Jun. 10, 2014 (JP) 2014-119894

(51) Int. Cl. G01F 1/66

(52) U.S. Cl. CPC G01F 1/66

(57) ABSTRACT

A clamp-on ultrasonic flowmeter includes: a first ultrasonic transducer that injects a first ultrasonic signal at an angle in excess of a critical angle into a pipe wherein a fluid flows; a second ultrasonic transducer, provided in a position able to receive the first ultrasonic signal, which injects a second ultrasonic signal at the same angle as the aforementioned angle, relative to the pipe; and a flow rate calculating portion that calculates either one of or both of a flow speed and a flow rate of the fluid within the pipe based on a first time for the first ultrasonic signal to pass through the interior of the pipe to arrive at the second ultrasonic transducer and a second time for the second ultrasonic signal to pass through the interior of the pipe to arrive at the first ultrasonic transducer.

### CROSS REFERENCE TO RELATED APPLICATION

This application claims priority under 35 U.S.C. §119 to Japanese Patent Application No. 2014-119894, filed on Jun. 10, 2014, the entire content of which being hereby incorporated herein by reference.

### FIELD OF TECHNOLOGY

The present invention relates to a fluid measuring technology, and, in particular, relates to a clamp-on ultrasonic flowmeter and to a flow rate measuring method.

### BACKGROUND

A clamp-on ultrasonic flowmeter is provided with respective ultrasonic transducers that are disposed on the upstream side and the downstream side on the outside of a pipe. Because typically clamp-on flowmeter uses ultrasound, in the specification below the “clamp-on ultrasonic flowmeter” may be abbreviated to simply a “clamp-on flowmeter.” The clamp-on flowmeter transmits ultrasound toward the fluid that is flowing within the pipe to calculate the flow speed and flow rate of the fluid flowing within the pipe based on the propagation time of the ultrasound that propagates along the upstream to downstream direction of the fluid and the propagation time for the ultrasound that propagates oppositely, from the downstream to the upstream direction. See, for example, European Patent No. 1173733. Because in a clamp-on flowmeter an ultrasonic transducer may be pressed against the outside of the pipe, there are benefits such as there being no need to cut the pipe at the time of installation, there being no contact with the fluid that flows within the hollow portion of the pipe, enabling measurement of corrosive fluids and eliminating deleterious effects on the purity of the fluid being measured, along with there no pressure loss through insertion of a structural object within the pipe, and the like.

An aspect of the present invention is to provide a clamp-on ultrasonic flowmeter and a flow rate measuring method able to measure the flow rate of a fluid accurately. Here the term “fluid” includes gases and liquids.

### SUMMARY

The present invention provides a clamp-on ultrasonic flowmeter including: a first ultrasonic transducer that injects a first ultrasonic signal at an angle in excess of a critical angle into a pipe wherein a fluid flows, to produce an evanescent wave in a wall of the pipe; a second ultrasonic transducer, disposed in a position able to receive the first ultrasonic signal, which injects a second ultrasonic signal at the same angle as the aforementioned angle of incidence of the first ultrasonic signal, relative to the pipe, to produce an evanescent wave in the wall of the pipe; and a flow rate calculating portion that calculates a flow speed and/or a flow rate of the fluid within the pipe based on a first time for the first ultrasonic signal to pass through the interior of the pipe to arrive at the second ultrasonic transducer and a second time for the second ultrasonic signal to pass through the interior of the pipe to arrive at the first ultrasonic transducer.

Another aspect of the present invention provides a method for measuring a flow rate, wherein: a first ultrasonic signal is injected by a first ultrasonic transducer at an angle in excess of a critical angle into a pipe wherein a fluid flows, to produce an evanescent wave in a wall of the pipe; a second ultrasonic signal is injected from a second ultrasonic transducer, disposed in a position able to receive the first ultrasonic signal, at the same angle as the angle of incidence of the first ultrasonic signal, relative to the pipe, to produce an evanescent wave in the wall of the pipe; and a flow speed and/or a flow rate of the fluid within the pipe is calculated based on a first time for the first ultrasonic signal to pass through the interior of the pipe to arrive at the second ultrasonic transducer and a second time for the second ultrasonic signal to pass through the interior of the pipe to arrive at the first ultrasonic transducer.

The present invention makes it possible to provide a clamp-on ultrasonic flowmeter and a flow rate measuring method able to measure the flow rate of a fluid accurately.

### BRIEF DESCRIPTIONS OF THE DRAWINGS

FIG. 1 is a schematic cross-sectional diagram of a clamp-on flowmeter according to an example according to the present invention.

FIG. 2 is a schematic cross-sectional diagram of a clamp-on flowmeter according to an example according to the present invention.

FIG. 3 is a schematic cross-sectional diagram of a clamp-on flowmeter according to an example according to the present invention.

FIG. 4 is a schematic cross-sectional diagram of a clamp-on flowmeter according to an example according to the present invention.

FIG. 5 is a schematic cross-sectional diagram of a conventional clamp-on flowmeter.

FIG. 6 is a graph of an ultrasound packet according to an example according to the present invention.

FIG. 7 is a graph of another ultrasound packet according to an example according to the present invention.

FIG. 8 is a graph of another ultrasound packet according to an example according to the present invention.

### DETAILED DESCRIPTION

Examples of the present invention will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

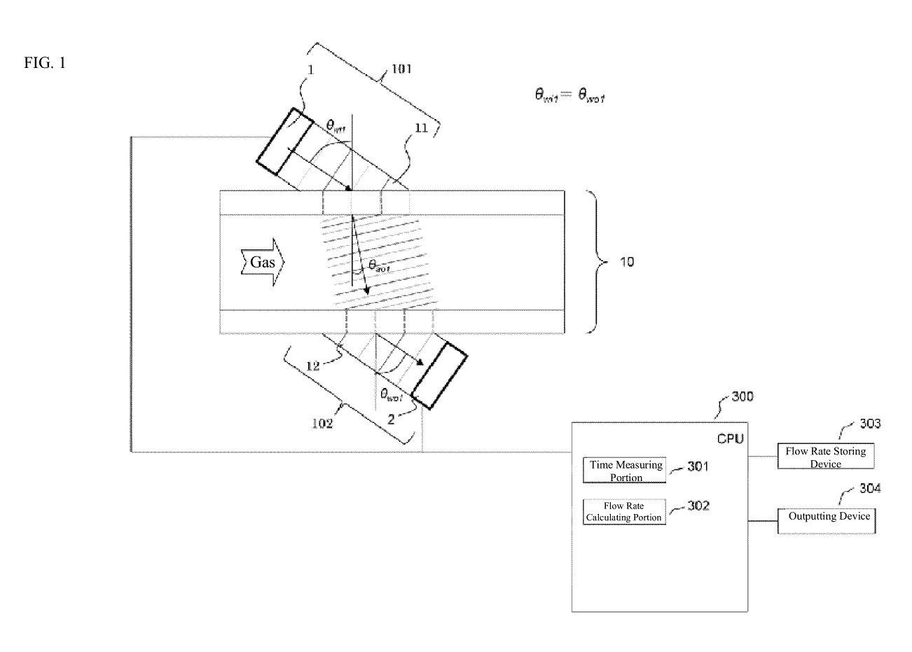

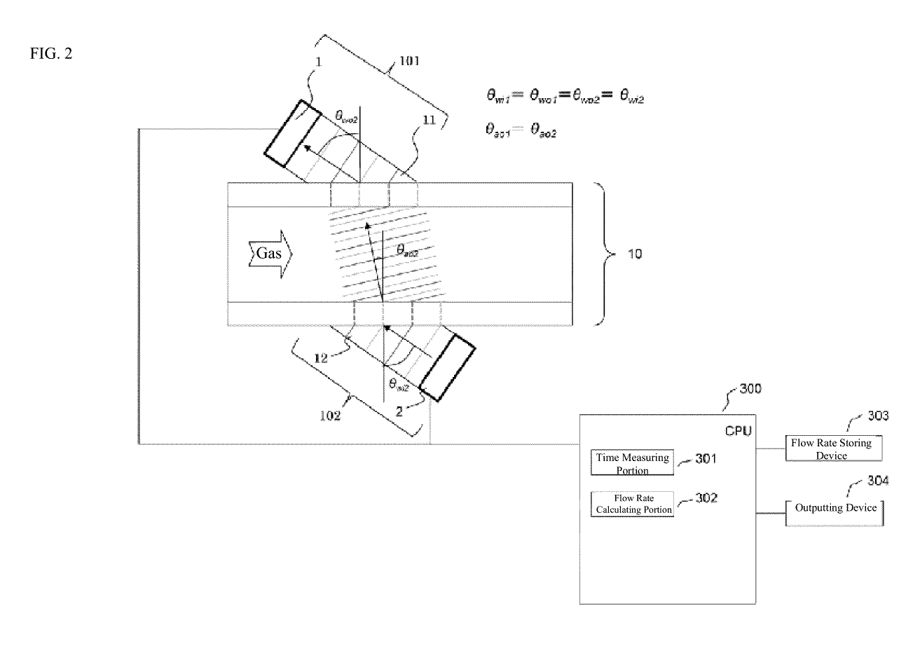

A clamp-on flowmeter according to an example, as illustrated in FIG. 1 and FIG. 2, includes: a first ultrasonic transducer 101 for generating an evanescent wave in a pipe wall of a pipe 10 by applying a first ultrasonic signal at an angle θ_{wi1}, which exceeds a critical angle, to the pipe 10, wherein a fluid is flowing; and a second ultrasonic transducer 102, disposed at a position able to receive the first ultrasonic signal, for generating an evanescent wave in the wall of the pipe 10 by applying, to the pipe 10, a second ultrasonic signal at an angle θ_{wi2}, which is identical to the incident angle θ_{wi1} of the first ultrasonic signal. The “fluid” is a gas or a liquid.

The first ultrasonic transducer 101 is disposed on the upstream side of the fluid that flows within the pipe 10, and the second ultrasonic transducers 102 is disposed on the downstream side. A first ultrasonic signal, emitted by the first ultrasonic transducer 101, passes through the pipe 10 to be received by the second ultrasonic transducer 102. A second ultrasonic signal, produced by the second ultrasonic transducer 102, passes through the pipe 10 to be received by the first ultrasonic transducer 101. Driving signals are applied, for example, alternatingly to the first ultrasonic transducer 101 and the second ultrasonic transducer 102, to emit ultrasonic signals alternatingly.

The first ultrasonic transducer 101 and the second ultrasonic transducer 102 are connected electrically to a central processing device (CPU) 300. This CPU 300 includes: a time measuring portion 301 for measuring a first time, for the first ultrasonic signal to arrive at the second ultrasonic transducer 102 through the pipe 10 after emission from the first ultrasonic transducer 101, and a second time, for the second ultrasonic signal to arrive at the first ultrasonic transducer 101 through the pipe after emission from the second ultrasonic transducer 102; and a flow rate calculating portion 302 for calculating the flow speed and/or flow rate of the fluid within the pipe 10 based on the first time and the second time.

The first ultrasonic transducer 101 includes, for example, a first oscillator 1 for emitting the first ultrasonic signal, and a first wedge 11, disposed on the outer surface of the pipe 10 so that the first ultrasonic signal will be incident onto the pipe 10 with an angle θ_{wi1}, which is greater than a critical angle. Similarly, the second ultrasonic transducer 102 includes, for example, a second oscillator 2 for emitting the second ultrasonic signal, and a second wedge 12, disposed on the outer surface of the pipe 10 so that the second ultrasonic signal will be incident onto the pipe 10 with an angle θ_{wi2}, which is greater than a critical angle. The pipe 10 is a metal pipe made of a metal material such as, for example, stainless steel. The first and second wedges 11 and 12 are made from a synthetic resin, or the like, such as a plastic, or the like, such as polyether imide, or the like.

When ultrasound propagates within an isotropic homogeneous solid, two types of plane waves can propagate, longitudinal waves and transverse waves, where these are known as “body waves.” The longitudinal waves and transverse waves are each refracted, following Snell's law, an interfaces between two media. When the speed of sound of the ultrasound at the first and second wedges 11 and 12 of the first and second ultrasonic transducers 101 and 102 is defined as c_{W} and the speed of sound of the ultrasound within the wall of the pipe 10 is defined as c_{P}, with the angle of incidence from the first wedge 11 relative to the interface between the first wedge 11 and the pipe 10 defined as θ_{wi1}, the angle of incidence from the second wedge 12 relative to the interface between the second legs 12 and the pipe 10 defined as θ_{wi2}, and the angle of emission into the wall of the pipe 10 defined as the θP, then, from the Snell's law, the following Equation (1) will be satisfied:

$$\begin{matrix}sin ( {θ}_{W i 1} ) / {c}_{W} = sin ( {θ}_{W i 2} ) / {c}_{W} \\ = sin ( θ P ) / {c}_{P}\end{matrix} \qquad ( 1 )$$

Consequently, the critical angle θc for the angle of incidence θW is given by Equation (2), below

$$\begin{matrix}θ c = {sin}^{- 1} ( {c}_{Wi 1} / {c}_{P} ) \\ = {sin}^{- 1} ( {c}_{Wi 2} / {c}_{P} )\end{matrix} \qquad ( 2 )$$

When the angle of incidence of the ultrasound exceeds the critical angle θc, then the ultrasound undergoes total internal reflection at the interface, so that the plane waves from the first and second wedges 11 and 12 will not propagate within the wall of the pipe 10. Because typically the critical angle for a transverse wave is greater than that for a longitudinal wave, when the angle of incidence is greater than the critical angle for the transverse wave, the plane waves for both the longitudinal waves and the transverse waves will not be able to propagate within the wall of the pipe 10. At this time, the sound field within the wall of the pipe 10 attenuates, in the direction perpendicular to the interface, exponentially, and undergoes periodic wave motion in any direction that is parallel to the interface. This sound field is known as an evanescent wave. The energy of an evanescent wave is concentrated in a range of about a wavelength from the interface along the direction that is perpendicular to the interface, and does not penetrate more deeply than that (referencing, for example, Choonnpa Yogo Jiten, 2005, Kogyo Chosakai, page 27).

In the case wherein the pipe is made from stainless steel (SUS 304), for example, the speed of sound of the longitudinal waves is 5780 m/s, and the speed of sound of the transverse waves is 3141 m/s. Because of this, in a pipe wall of a pipe 10 made from SUS 304, the wavelength for a longitudinal wave of ultrasound at, for example, 1 mHz will be 5.8 mm and the wavelength for a transverse wave will be 3.1 mm. Consequently, if the pipe wall is several millimeters thick, the evanescent wave that is produced on the outer surface side of the pipe 10 can penetrate to the inner surface side. Because the evanescent wave penetrates in the direction that is parallel to the direction that is normal to the exterior surface, it will be transmitted to the internal surface without changing the spacing between the peaks and between the troughs in the evanescent wave. The penetration of the evanescent wave to the interior surface of the pipe 10 causes a plane wave to be limited, as the first ultrasonic signal, from within the wall of the pipe 10 in the direction of the fluid within the pipe 10. Because the spacing between the peaks and between the troughs of the ultrasonic vibration is the same for both the outer surface and the inner surface of the wall of the pipe 10, it is possible to remove the pipe wall part when applying Snell's law. Given this, if the speed of sound of the ultrasound within the fluid within the pipe 10 is defined as cₐ, then the angle of emission θₐₒ₁ of the plane wave that is emitted is given by Equation (3), below:

θₐₒ₁=sin⁻¹(sin θ_{wi1}·cₐ/c_{W}) (3)

The plane waves, as the first ultrasonic signal, propagate within the fluid within the pipe 10, to be incident onto the part that faces the emitting part of the wall of the pipe 10. Given this, an evanescent wave is produced again, where the evanescent wave, as the first ultrasonic signal, penetrates into the wall of the pipe 10. Moreover, the plane wave, as the first ultrasonic signal, is emitted to the outside of the pipe at an angle θ_{wo1} that is the same as the angle θ_{wi1}, from the wall of the pipe 10, to be detected by the second ultrasonic transducer 102.

The plane wave for the second ultrasonic signal, emitted from the second ultrasonic transducer 102 is also incident into the pipe 10 at an angle θ_{wi2} that exceeds the critical angle, to produce an evanescent wave within the wall of the pipe 10. This evanescent wave, as the second ultrasonic signal, penetrates into the wall of the pipe 10. The penetration of the evanescent wave to the interior surface of the pipe 10 causes the plane waves, as the second ultrasonic signal, to be emitted in the direction of the fluid within the pipe 10 from within the wall of the pipe 10, where the plane wave is incident into the part that faces the emitting part of the wall of the pipe 10. Given this, an evanescent wave is produced again, where the evanescent wave, as the second ultrasonic signal, penetrates into the wall of the pipe 10. Moreover, the plane wave, as the second ultrasonic signal, is emitted to the outside of the pipe at an angle θ_{wo2} that is the same as the angle θ_{wi2} from the wall of the pipe 10, to be detected by the first ultrasonic transducer 101.

Within the pipe 10, a fluid is flowing with a flow speed v. As described above, the first ultrasonic transducer 101 is disposed on the upstream side of the fluid that flows within the pipe 10, and the second ultrasonic transducer 102 is disposed on the downstream side. Because of this, the first ultrasonic signal that is produced from the first ultrasonic transducer 101 propagates, along the flow of the fluid, through the hollow portion within the pipe 10. In contrast, the second ultrasonic signal that is produced by the second ultrasonic transducer 102 propagates opposite to the flow of the fluid through the hollow portion within the pipe 10. Consequently, in the hollow portion within the pipe 10, a difference will be produced between the propagation time for the first ultrasonic signal and the propagation time for the second ultrasonic signal due to the flow speed v of the fluid.

The propagation time t₁ required for the first ultrasonic signal to traverse the hollow portion within the pipe 10 is given by the following Equation (4):

t₁=L/(cₐ+v·cos((π/2)−θₐₒ₁)) (4)

Additionally, the propagation time t₂ required for the second ultrasonic signal to traverse the hollow portion within the pipe 10 is given by the following Equation (5):

t₂=L/(cₐ−v·cos((π/2)−θₐₒ₂)) (5)

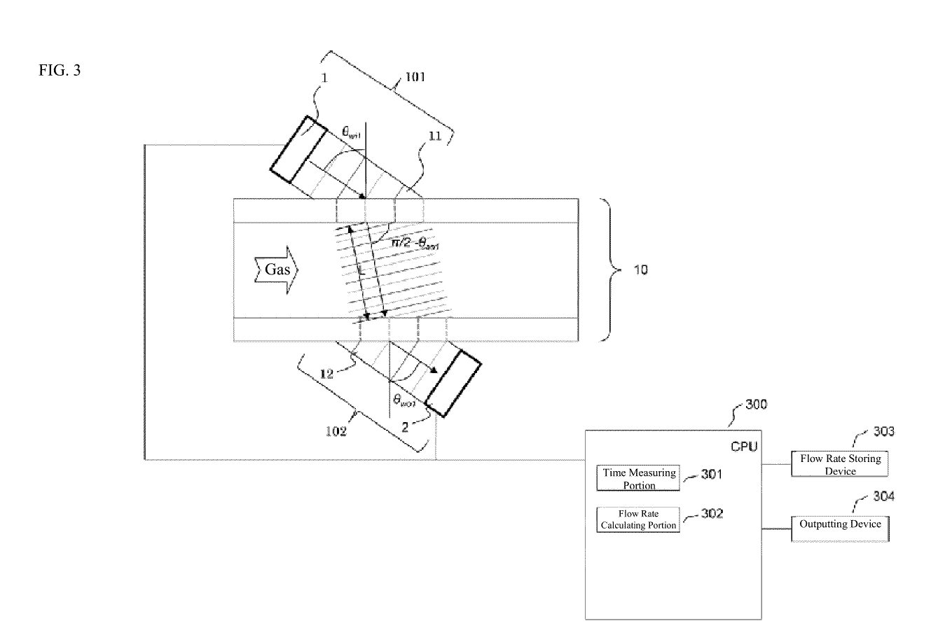

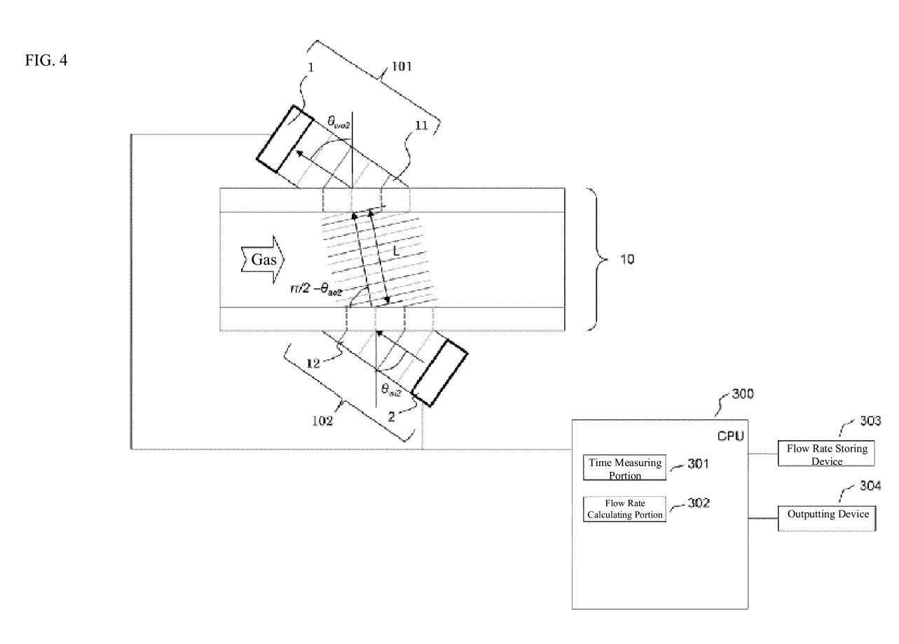

Here FIG. 3 and FIG. 4 illustrate the lengths that cut across the hollow portion of the pipe 10 for the first ultrasonic signal and the second ultrasonic signal, respectively.

Moreover, because θao2 is an equal to θₐₒ₁, Equation (6), below, is derived from Equation (5), above:

t₂=L/(cₐ−v·cos((π/2)−θₐₒ₁)) (6)

The difference Δt between the propagation time t₂ and the propagation time t₁, from Equations (4) and (6), above, is given by Equation (7), below:

Δt=t₂−t₁ approximately (2Lv·sin θₐₒ₁)/cₐ² (7)

Given Equation (7), above, the flow speed v of the fluid that flows within the hollow portion of within the pipe 10 is given by Equation (8), below:

v=cₐ²Δt/(2L·sin θₐₒ₁) (8)

Here the emission angle θₐₒ₁ can be calculated from Equation (3), above. The length L can be calculated from the diameter of the pipe 10 and the emission θₐₒ₁. Moreover, the speed of sound cₐ within the fluid that flows in the hollow portion within the pipe 10 is a constant that is determined by the type of fluid and the temperature. Consequently, by measuring the difference Δt between the propagation times of the first and second ultrasonic signals it becomes possible to calculate the flow speed v of the fluid that flows within the hollow portion within the pipe 10.

Furthermore, the flow rate q of the fluid that flows within the hollow portion within the pipe 10 can be calculated from Equation (9), below:

q=kSv (9)

Here, in this equation (9), k is a flow rate correcting coefficient and S is the cross-sectional area of the pipe 10. When the interior diameter of the pipe 10 is defined as D, then:

L=D/cos(θₐₒ₁)

S=πD2/4

Because of this, the flow rate q of the fluid, from Equations (8) and (9), may be expressed as follows:

q=πkDcₐ²Δt/(4·tan θₐₒ₁) (9′)

The time measuring portion 301, shown in FIG. 1 through FIG. 4, monitors the time at which the first ultrasonic transducer 101 emits the first ultrasonic signal and the time at which the second ultrasonic transducer 102 receives the first ultrasonic signal, to measure the first time with which the first ultrasonic signal passes through the interior of the pipe 10 to arrive at the second ultrasonic transducer 102 after emission from the first ultrasonic transducer 101. In addition, the time measuring portion 301 monitors the time at which the second ultrasonic transducer 102 emits the second ultrasonic signal and the time at which the first ultrasonic transducer 101 receives the second ultrasonic signal, to measure the second time with which the second ultrasonic signal passes through the interior of the pipe 10 to arrive at the first ultrasonic transducer 101 after emission from the second ultrasonic transducer 102.

The time measuring portion 301 calculates the value of the difference between the second time and the first time and sends it to the flow rate calculating portion 302. Note that the difference between the second time and the first time may instead be a direct measurement by the time measuring portion 301. Here no differences are produced between the propagation time of the first ultrasonic signal and the propagation time of the second ultrasonic signal within the first and second wedges 11 and 12 or within the wall of the pipe 10. Consequently, the difference between the second time and the first time is produced by only the difference At between the propagation time t₂ and the propagation time t₁ within the hollow portion within the pipe 10, given by Equation (7), above.

The flow rate calculating portion 302 calculates, for example, the value of the emission angle θₐₒ₁ of the first ultrasonic signal that is emitted into the hollow portion from the wall of the pipe 10, based, on Equation (3), above. Note that a previously calculated emission angle θₐₒ₁ may be stored by the flow rate portion 302 instead.

The flow rate calculating portion 302 calculates the flow speed v of the fluid that flows within the hollow portion within the pipe 10 by substituting the calculated value into the variable on the right side in Equation (8), above. Note that the flow rate calculating portion 302 may instead calculate the flow speed based on a difference between the inverse of the first time and the inverse of the second time. Moreover, the flow rate calculating portion 302 calculates the flow rate q of the fluid that flows through the hollow portion within the pipe 10 by substituting the calculated value into the variable on the right side in Equation (9), above. A flow rate storing device 303 and an outputting device 304 are connected to the CPU 300. The flow rate calculating portion 302 saves, to the flow rate storing device 303, and outputs, to the outputting device 304, the calculated flow speed v and flow rate q for the fluid.

At the end of diligent research, the present inventors discovered the following knowledge. Specifically, in a conventional clamp-on flowmeter, the ultrasonic signal is injected at an angle that does not exceed a critical angle in relation to the pipe, so as to not produce total internal reflection at the junction portion between the wedge 11 and the pipe 10. Because of this, the body waves enter into the wall of the pipe without total reflection. Moreover, depending on the thickness of the wall of the pipe, both body waves and guide waves of a plurality of types of different forms of propagation are produced and exist together within the pipe wall. However, ultrasonic signals with different forms of propagation will each have its own speed of sound. Because of this, a distribution will be produced within the propagation times for the ultrasound that is measured, producing error in the calculated fluid flow speed.

In contrast, in the example according to the present invention, the ultrasonic signal is injected at an angle that exceeds the critical angle for the pipe 10, to cause the body waves to undergo total internal reflection, so that an evanescent wave will be produced within the wall of the pipe. As a result, there will not be multiple reflections within the wall of the pipe, making it possible to suppress the error in the measured fluid flow speeds.

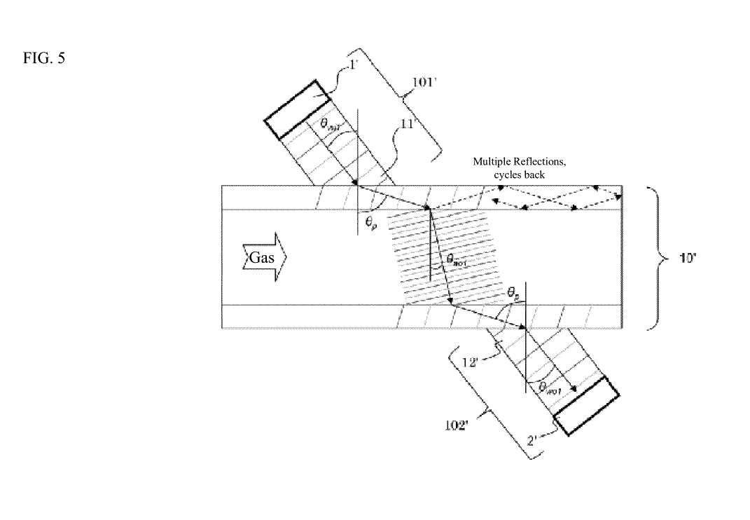

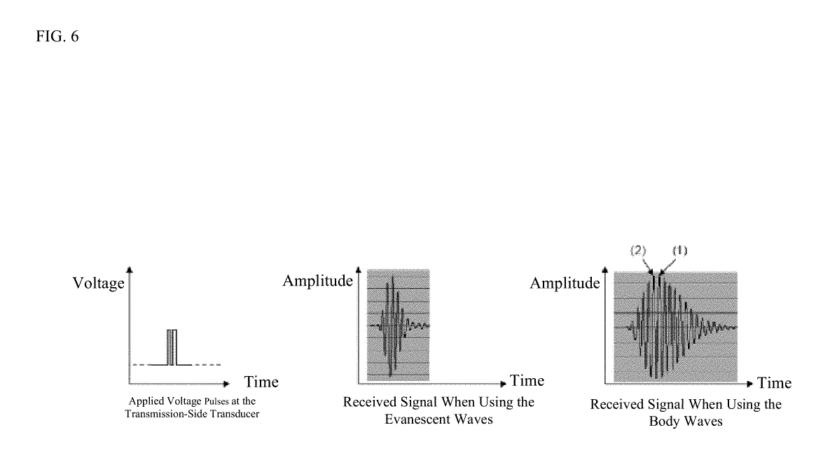

Moreover, as illustrated in FIG. 5, because, in a conventional clamp-on flowmeter, the ultrasonic signal is injected at an angle that is not greater than the critical angle for the pipe, multiple reflections of the ultrasound are produced within the wall of the pipe. However, when multiple reflections are produced, then, as illustrated in FIG. 6, in the ultrasonic transducer on the receiving side, the waveform will spread temporally, which may make it difficult to specify whether the amplitude peak is that (1) or at (2). Because of this, it may be difficult to specify the propagation time of the ultrasound. In contrast, the use of an evanescent wave, which does not produce multiple reflections, makes it possible to suppress the temporal spread of the waveform at the ultrasonic transducer on the receiving side. Because of this, the signal waveform becomes sharp, making it easy to identify the propagation time for the ultrasound. Moreover, because the ultrasound that undergoes multiple reflections within the wall of the pipe in the conventional clamp-on flowmeter is reflected by flange surfaces, and the like, in the pipe, signals other than the actual ultrasound signal are received by the ultrasonic transducer on the receiving side, which may have an effect on the proper measurement. In contrast, the use of an evanescent wave, which does not produce multiple reflections, makes it possible to receive the actual reception signal with a high S/N ratio by the ultrasonic transducer on the receiving side.

### Examples

A stainless steel (SUS 304) steel pipe (40A-sch40), having a wall thickness of 3.7 mm, was prepared. Sending-side and receiving-side ultrasonic transducers, having respective wedges made from polyether imide, were disposed thereon. The wedges were manufactured so as to have angles of incidence of 54° and 57° for the ultrasound into the stainless steel.

The speed of sound of the longitudinal waves for the ultrasound in the polyether imide was 2438 m/s. Moreover, the speed of sound for the longitudinal waves of the ultrasound in the stainless steel was 5780 m/s, and the speed of sound of the transverse waves thereof was 3141 m/s, so the critical angles for the longitudinal wave and for the transverse wave were, respectively, 24.90° and 50.9°. When the angle of incidence exceeds 50.9°, the body waves (the longitudinal waves and the transverse waves) in the ultrasound cannot propagate into the pipe, producing a state that is qualitatively different, rather than being simply a quantitative problem regarding the angle.

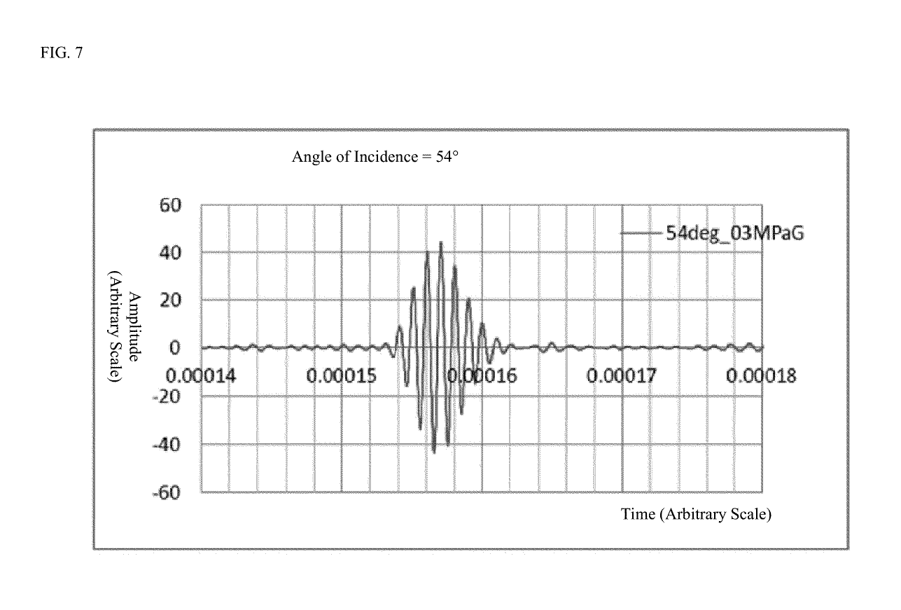

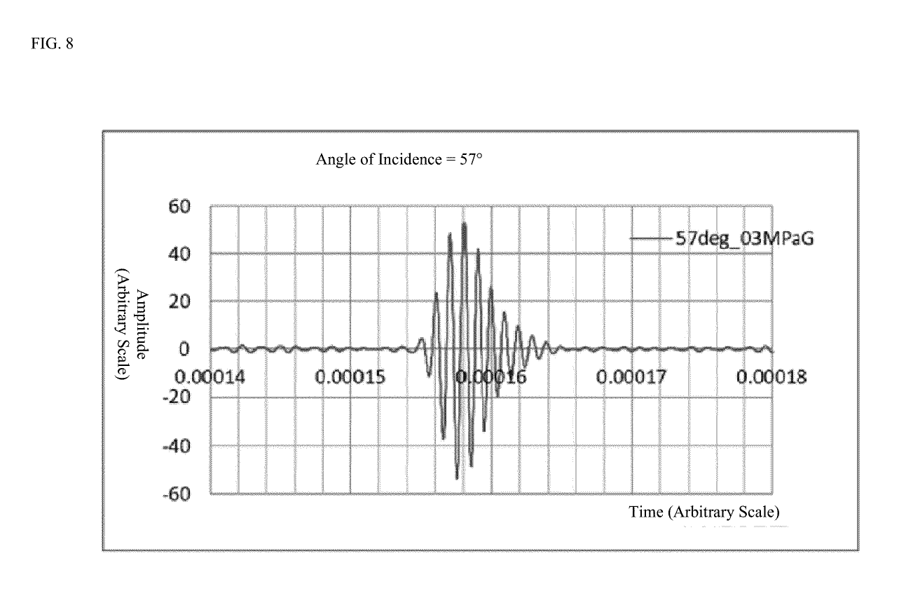

When an ultrasonic signal was emitted by the transmitting-side ultrasonic transducer, with a flow of compressed air at 0.3 MPaG within the stainless steel pipe, the temporal spread was suppressed at both angles of incidence of 54° and 57°, as illustrated in FIG. 7 and FIG. 8, making it possible to receive, by the receiving-side ultrasonic transducer, an ultrasonic signal of an adequate amplitude.

### Other Examples

While there are descriptions of examples as set forth above, the descriptions and drawings that form a portion of the disclosure are not to be understood to limit the present disclosure. A variety of alternate examples and operating technologies should be obvious to those skilled in the art. For example, the material for the wedge is not limited to polyether imide, nor is the material for the pipe limited to stainless steel. In this way, the present disclosure should be understood to include a variety of examples, and the like, not set forth herein.

1. A clamp-on ultrasonic flowmeter comprising:
a first ultrasonic transducer that injects a first ultrasonic signal at an angle in excess of a critical angle into a pipe wherein a fluid flows, to produce an evanescent wave in a wall of the pipe;
a second ultrasonic transducer, provided in a position able to receive the first ultrasonic signal, which injects a second ultrasonic signal at the same angle as the aforementioned angle, relative to the pipe, to produce an evanescent wave in the wall of the pipe; and
a flow rate calculating portion that calculates either one of or both of a flow speed and a flow rate of the fluid within the pipe based on a first time for the first ultrasonic signal to pass through the interior of the pipe to arrive at the second ultrasonic transducer and a second time for the second ultrasonic signal to pass through the interior of the pipe to arrive at the first ultrasonic transducer.

2. The clamp-on ultrasonic flowmeter as set forth in claim 1, wherein:
the first ultrasonic signal and the second ultrasonic signal penetrate, as evanescent waves, between the outer surface and the inner surface of the wall of the pipe.

3. The clamp-on ultrasonic flowmeter as set forth in claim 1, wherein:
the first ultrasonic transducer comprises a first oscillator that produces the first ultrasonic signal, and a first wedge that is provided on the pipe so that the first ultrasonic signal is injected at an angle that is in excess of the critical angle.

4. The clamp-on ultrasonic flowmeter as set forth in claim 1, wherein:
the second ultrasonic transducer comprises a second oscillator that produces the second ultrasonic signal, and a second wedge that is provided on the pipe so that the second ultrasonic signal is injected at an angle that is in excess of the critical angle.

5. The clamp-on ultrasonic flowmeter as set forth in claim 1, wherein:
the flow rate calculating portion calculates either one of or both of a flow speed and flow rate of the fluid within the pipe based on emission angles of the first and second ultrasonic signals that are emitted from the wall of the pipe into a hollow portion within the pipe.

6. The clamp-on ultrasonic flowmeter as set forth in claim 5, wherein:
an emission angle of the first ultrasonic signal, emitted into the hollow portion from the wall of the pipe, is calculated based on an angle of incidence of the first ultrasonic signal from the first ultrasonic transducer into the pipe, a speed of sound of the first ultrasonic signal in the first ultrasonic transducer, and a speed of sound of the first ultrasonic signal in the fluid that flows in the hollow portion.

7. The clamp-on ultrasonic flowmeter as set forth in claim 5, wherein:
an emission angle of the second ultrasonic signal, emitted into the hollow portion from the wall of the pipe, is calculated based on an angle of incidence of the second ultrasonic signal from the second ultrasonic transducer into the pipe, a speed of sound of the second ultrasonic signal in the second ultrasonic transducer, and a speed of sound of the second ultrasonic signal in the fluid that flows in the hollow portion.

8. The clamp-on ultrasonic flowmeter as set forth in claim 1, wherein:
the pipe is a metal pipe.

9. The clamp-on ultrasonic flowmeter as set forth in claim 1, wherein:
the fluid is a gas.

10. A method for measuring a flow rate, comprising:
an injection step in which a first ultrasonic signal is injected at an angle in excess of a critical angle into a pipe wherein a fluid flows, to produce an evanescent wave in a wall of the pipe;
another injection step in which a second ultrasonic signal is injected from a second ultrasonic transducer, provided in a position able to receive the first ultrasonic signal, at the same angle as the aforementioned angle, relative to the pipe, to produce an evanescent wave in the wall of the pipe; and
a calculation step in which either one of or both of a flow speed and a flow rate of the fluid within the pipe are calculated based on a first time for the first ultrasonic signal to pass through the interior of the pipe to arrive at the second ultrasonic transducer and a second time for the second ultrasonic signal to pass through the interior of the pipe to arrive at the first ultrasonic transducer.

11. The method for measuring a flow rate as set forth in claim 10, wherein:
the first ultrasonic signal and the second ultrasonic signal penetrate, as evanescent waves, between the outer surface and the inner surface of the wall of the pipe.

12. The method for measuring a flow rate as set forth in claim 10, wherein:
the first ultrasonic transducer comprises a first oscillator that produces the first ultrasonic signal, and a first wedge that is provided on the pipe so that the first ultrasonic signal is injected at an angle that is in excess of the critical angle.

13. The method for measuring a flow rate as set forth in claim 10, wherein:
the second ultrasonic transducer comprises a second oscillator that produces the second ultrasonic signal, and a second wedge that is provided on the pipe so that the second ultrasonic signal is injected at an angle that is in excess of the critical angle.

14. The method for measuring a flow rate as set forth in claim 10, wherein:
either one of or both of a flow speed and flow rate of the fluid within the pipe are calculated based on emission angles of the first and second ultrasonic signals that are emitted from the wall of the pipe into a hollow portion within the pipe.

15. The method for measuring a flow rate as set forth in claim 14, wherein:
an emission angle of the second ultrasonic signal, emitted into the hollow portion from the wall of the pipe, is calculated based on an angle of incidence of the second ultrasonic signal from the second ultrasonic transducer into the pipe, a speed of sound of the second ultrasonic signal in the second ultrasonic transducer, and a speed of sound of the second ultrasonic signal in the fluid that flows in the hollow portion.

16. The method for measuring a flow rate as set forth in claim 14, wherein:
an emission angle of the second ultrasonic signal, emitted into the hollow portion from the wall of the pipe, is calculated based on an angle of incidence of the second ultrasonic signal from the second ultrasonic transducer into the pipe, a speed of sound of the second ultrasonic signal in the second ultrasonic transducer, and a speed of sound of the second ultrasonic signal in the fluid that flows in the hollow portion.

17. The method for measuring a flow rate as set forth in claim 10, wherein:
the pipe is a metal pipe.

18. The method for measuring a flow rate as set forth in claim 10, wherein:
the fluid is a gas.
